(19) United States
(12) Patent Application Publication
(10) Pub. No.: US 2025/0366442 A1
(43) Pub. Date: Dec. 4, 2025

(54) Pet Comb

(71) Applicant: Shenzhen Tongchuang Technology Co., Ltd., Shenzhen (CN)

(72) Inventor: Qin Zhang, Shenzhen (CN)

(21) Appl. No.: 18/732,907

(22) Filed: Jun. 4, 2024

(30) Foreign Application Priority Data
May 28, 2024 (CN) 202421200011X

(51) Int. Cl. A01K 13/00

(52) U.S. Cl. CPC A01K 13/002

(57) ABSTRACT

A pet comb includes a handle, a combing component and an electrostatic component, wherein the combing component includes a combing base and a combing part. The combing base is connected to the handle, and the combing part is arranged on the combing base; wherein the electrostatic component is arranged on one side of the handle; the combing part is configured as an arc-shaped structure and the arc-shaped structure extends toward the electrostatic component. By the means of setting an electrostatic component, the occurrence of flying pet hair can be reduced.

### TECHNICAL FIELD

The present utility patent relates to the technical field of pet hair removal, in particular to a pet comb.

### BACKGROUND

A pet comb is a tool specially used for pet grooming and pet hair care. By gently combing the pet hair, it can remove knotted and shed hair and impurities adhering to the pet hair. While combing, it can also gently massage pet's skin to promote blood circulation of pet's skin, helping to maintain pet's skin health and hair growth.

However, when existing pet combs are used to comb pet hair, static electricity or friction on surface may cause the shed hair to be electrostatic, thereby adhering to the pet comb or surrounding objects. After combing the pet hair, people also need to clean the pet comb and the surrounding environment to avoid affecting the environmental hygiene at home.

### SUMMARY

In order to overcome the defect of prior art, the present utility patent provides a pet comb which is capable of reducing the occurrence of flying pet hair.

To solve the technical problem, the present utility patent adopts the following technical solutions:

A pet comb includes a handle, a combing component and an electrostatic component, wherein the combing component includes a combing base and a combing part. The combing base is connected to the handle, the combing part is arranged on the combing base, the electrostatic component is arranged on one side of the handle. The combing part is configured as an arc-shaped structure, and the arc-shaped structure extends toward the electrostatic component.

Further, the pet comb includes a fixed base, wherein the fixed base is connected to the handle, and the combing base is connected to the fixed base.

Further, both sides of the fixed base are provided with a first opening, wherein the first opening is used for the combing base to pass through, a bottom of the fixed base is provided with a plurality of first limiting holes, a bottom of the combing base is provided with a plurality of first inverted buckles to match with the first limiting holes; a top of the fixed base is provided with a plurality of second limiting holes, a top of the combing base is provided with a plurality of second inverted buckles to match with the second limiting holes.

Further, the pet comb includes a hair removal device, wherein the hair removal device is detachably connected to the fixed base and is covered above the combing part. A toothed hair removal razor is arranged on one side of the hair removal device facing to the combing part. The combing part includes a hair comb, the hair removal razor and the hair comb are arranged in a staggered manner.

Further, the fixed base is provided with a column structure, the hair removal device is provided with a snap ring structure, the snap ring structure is provided with an opening, the snap ring structure is sleeved and connected to outer periphery of the column structure through the opening, the hair removal device is capable of rotating with a rotating shaft of the column structure, a reset device is arranged between the hair removal device and the fixed base.

Further, both ends of the hair removal device are provided with through holes, both ends of the fixed base are provided with protruding structures, one end of the reset device is sleeved and connected on the protruding structure and is locked and fixed by screws, other end of the reset device is connected into the through hole, the reset device is made of elastic material.

Further, the electrostatic component includes an electrostatic base and an electrostatic cloth, the electrostatic cloth is capable of detachably connecting to the electrostatic base, the electrostatic base is connected to the fixed base.

Further, the fixed base is connected to the handle, the electrostatic base is provided with a plurality of third inverted buckles, the fixed base is provided with a plurality of third limiting holes, the handle is provided with a plurality of first limiting columns, the third inverted buckles and the first limiting columns are capable of inserting into the third limiting holes.

Further, the handle includes a handle top cover and a handle bottom cover. The handle top cover is provided with a plurality of second limiting columns, the handle bottom cover is provided with a plurality of fourth limiting holes, the fourth limiting holes and the second limiting columns are matched to each other. The fixed base is provided with a plurality of third limiting columns, the handle bottom cover is provided with a plurality of fifth limiting holes, the third limiting columns and the fifth limiting holes are matched to each other.

Further, the handle bottom cover is provided with an installation slot, the handle top cover and the handle bottom cover are enclosed to form a second opening on one end of the handle, the second opening is connected with the installation slot.

The beneficial effects of the present utility patent are:

The present utility patent provides a pet comb. By the means of setting an electrostatic component, the electrostatic component is capable of generating static electricity so that the pet hair adheres to the pet comb, thereby reducing the occurrence of flying pet hair.

### BRIEF DESCRIPTION OF THE DRAWINGS

FIG. 1 is a schematic diagram of overall pet comb of the present utility patent;

FIG. 2 is a top side exploded view thereof;

FIG. 3 is a bottom side exploded view thereof;

FIG. 4 is an enlarged schematic diagram of A in FIG. 2;

FIG. 5 is an exploded view of the structure of the fixed base and combing component in the present utility patent;

FIG. 6 is an exploded view of the structure of the fixed base and the combing component in the present utility patent from another angle;

FIG. 7 is an exploded view of the structure of the fixed base and the electrostatic component of the present utility patent;

FIG. 8 is a schematic diagram of the hair removal device of the present utility patent;

### REFERENCE SIGNS IN THE DRAWINGS

1. handle; 10. handle bottom cover; 101. first limiting column; 102. fourth limiting hole; 103. installation slot; 104. fifth limiting hole; 11. handle top cover; 110. second limiting column; 12. hanging rope;
2. combing component; 20. combing part; 21. combing base; 211. first inverted buckle; 212. second inverted buckle;
3. hair removal device; 30. hair removal razor; 31. through hole; 32. snap ring structure; 33. reset device;
4. fixed base; 41. first limiting hole; 42. second limiting hole;
43. column structure; 44. protruding structure; 45. third limiting hole; 46. third limiting column;
5. electrostatic component; 50. electrostatic base; 501. third inverted buckle; 51. electrostatic cloth.

### DESCRIPTION OF EMBODIMENTS

In conjunction with the embodiments and drawings, the concept, specific structure and technical effects of the present utility patent will be clearly and completely described below to fully understand the purpose, features and effects of the present utility patent. Obviously, the described embodiments are only some of the embodiments of the present utility patent, rather than all the embodiments. Based on the embodiments of the present utility patent, other embodiments that those skilled in the art can obtain without exerting creative efforts all belong to the protection scope of the present utility patent. In addition, all the connection relationships involved in the patent do not only refer to the direct connection of components, but refer to the fact that a better connection structure can be formed by adding or reducing connection auxiliary parts according to the specific implementation conditions. Various technical features in the creation of the present utility patent can be combined interactively without conflicting to each other.

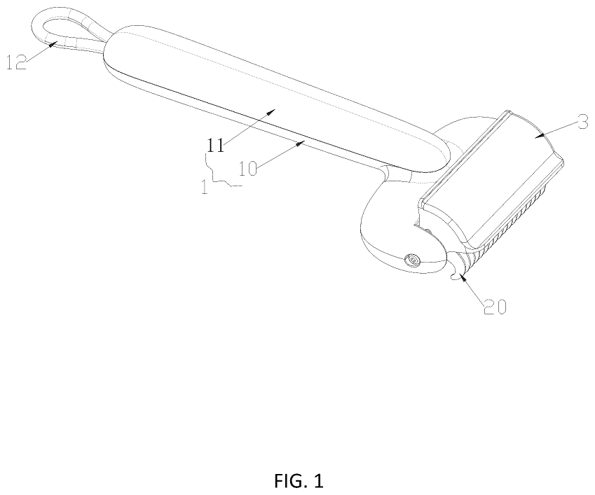

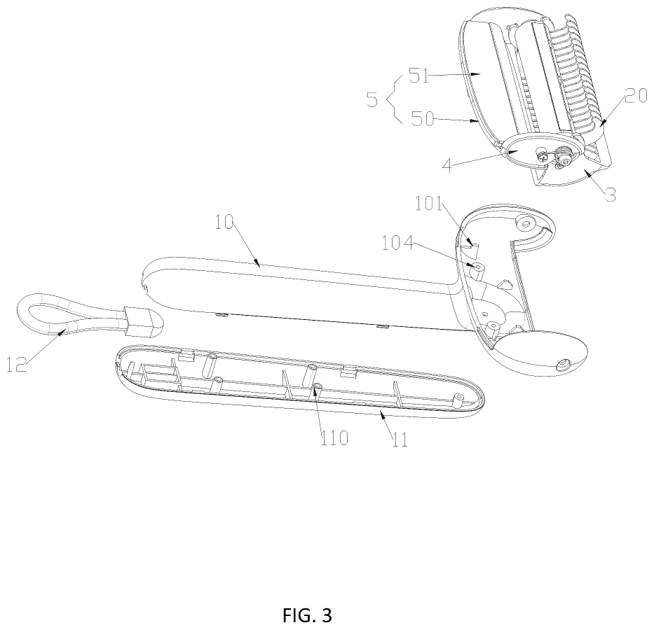

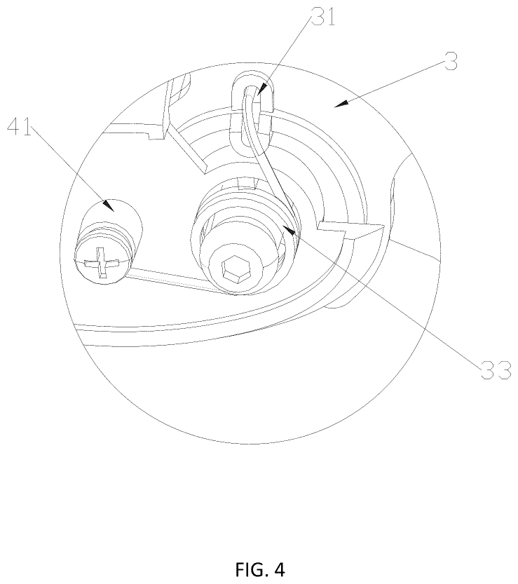

Referring to FIGS. 1 to 8, the present utility patent provides a pet comb. By the means of setting an electrostatic component 5, when the pet comb is used for combing pet hair, the electrostatic component 5 can generate static electricity, causing the pet hair to adhere on the pet comb, thereby reducing the occurrence of flying pet hair.

Referring to FIGS. 1, 3 and 7, the present utility patent provides a pet comb, including a handle 1, a combing component 2 and an electrostatic component 5. The handle 1 is used for holding by the user, and the combing component 2 is used for combing the pet hair, the electrostatic component 5 is used for generating static electricity to adsorb pet hair.

Referring to FIGS. 1, 3, 5 and 6, the combing component 2 includes a combing base 21 and a combing part 20. The combing base 21 is connected to the handle 1, and the combing part 20 is arranged on the combing base 21. The electrostatic component 5 is arranged on one side of the handle 1, the combing part 20 is configured as an arc-shaped structure, and the arc-shaped structure extends toward the electrostatic component 5.

It can be understood that the extension direction of the arc-shaped structure is the combing direction of the pet comb. When using the pet comb to comb pet hair, the pet comb needs to be moved along the direction in which the arc-shaped structure extends. The electrostatic component 5 is arranged in the combing direction of the combing part 20 and can contact the pet hair earlier than the combing part 20. Before combing, the electrostatic component 5 first generates static electricity to absorb the floating hair on surface of the pet, and then the combing part 20 grooming the pet hair, which can reduce the occurrence of flying hair.

Referring to FIGS. 1 to 3, in this embodiment, the pet comb further includes a fixed base 4, the fixed base 4 is connected to the handle 1, and the combing component 2 and the electrostatic component 5 are both connected to the fixed base 4.

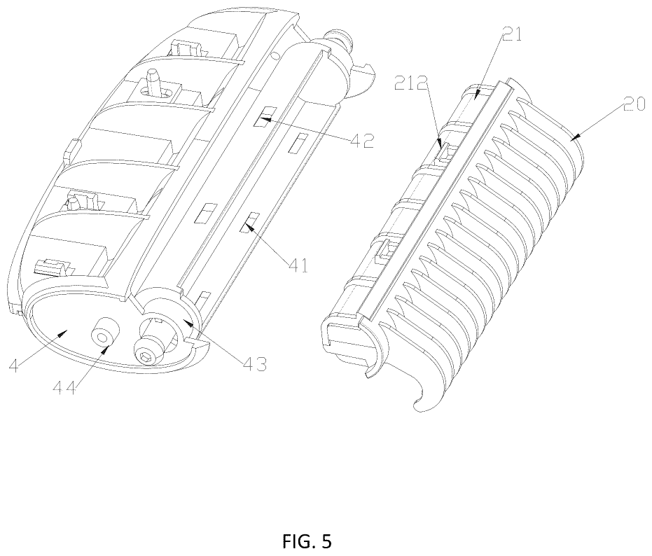

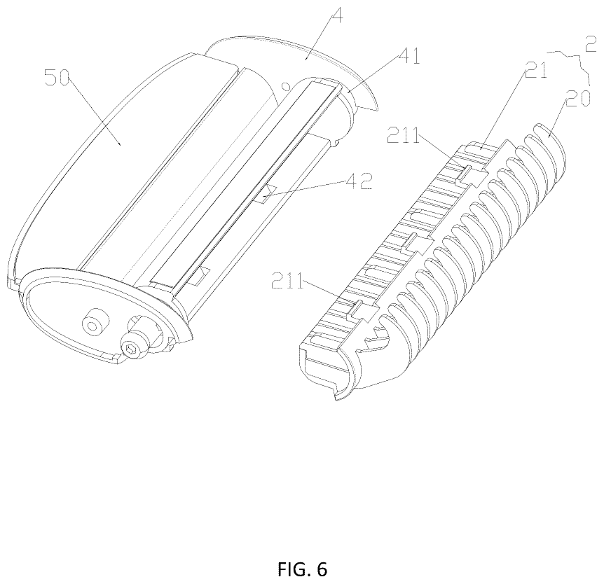

Referring to FIGS. 5 and 6, in this embodiment, the combing component 2 is connected to the fixed base 4 through the combing base 21. Specifically, a first opening (not shown in the figure) is arranged on one side of the fixed base 4, and the combing base 21 is assembled into the fixed base 4 through the first opening. The bottom of the fixed base 4 is provided with a plurality of first limiting holes 41, and the bottom of the combing base 21 is provided with a plurality of first inverted buckles 211. The first inverted buckles 211 and the first limiting holes are matched to each other. The top of the fixed base 4 is provided with a plurality of second limiting holes 42, and the top of the combing base 21 is provided with a plurality of second inverted buckles 212. The second inverted buckles 212 and the second limiting holes 42 are matched to each other. By the means of setting two sets of inverted buckles, the connection between the combing base 21 and the fixed base 4 is realized.

Referring to FIGS. 1, 2 and 8, in this embodiment, the pet comb further includes a hair removal device 3, wherein the hair removal device 3 is movably connected to the fixed base 4 and is covered above the combing part 20. The hair removal device 3 is provided with a toothed hair removal razor 30 on one side facing to the combing part 20. The combing part 20 includes a toothed hair comb. The hair removal razor 30 and the hair comb are arranged in a staggered manner.

After using the current regular pet comb to comb the pet, the combed hair will be entangled on the hair comb, and the entangled hair needs to be manually removed with a toothpick or a small blade. The hair removal device 3 designed by the present utility patent can conveniently remove hair.

It can be understood that when a force is applied to the hair removal device 3 so that the hair removal device 3 moves toward the hair comb, the hair removal razor 30 can be inserted into the toothed gap of the hair comb, and can lift up the hair entangled on the hair comb to achieve the cleaning function.

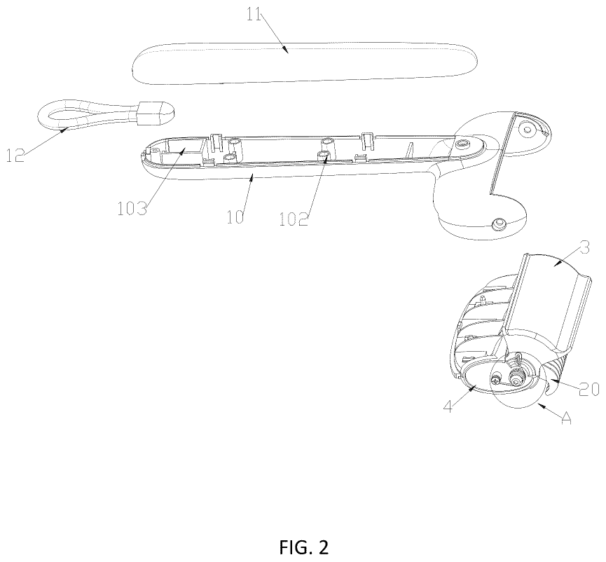

Referring to FIGS. 2 to 4, further, the fixed base 4 is provided with a column structure 43, the hair removal device 3 is provided with a snap ring structure 32, the snap ring structure 32 is provided with an opening, and the snap ring structure 32 is sleeved and connected on the outer periphery of the column structure 43 through the opening, the hair removal device 3 can rotate with a rotating shaft of the column structure 43. A reset device 33 is arranged between the hair removal device 3 and the fixed base 4. When it is necessary to clean the hair entangled on the hair comb, a force is applied to the hair removal device 3 to move toward the hair comb; when the cleaning is completed, no force is applied to the hair removal device 3, and the hair removal device 3 can be restored to the initial position under the action of the reset device 33.

Both ends of the hair removal device 3 are provided with through holes 31, both ends of the fixed base 4 are provided with protruding structures 44, one end of the reset device 33 is sleeved and connected on the protruding structure 44 and is locked and fixed by screws, other end of the reset device 33 is inserted into the through hole 31. The reset device 33 is made of elastic material. In this embodiment, the reset device 33 adopts a torsional spring.

Referring to FIG. 7, in this embodiment, the electrostatic component 5 includes an electrostatic base 50 and an electrostatic cloth 51. The electrostatic cloth 51 is detachably connected to the electrostatic base 50 to facilitate the replacement of the electrostatic cloth 51. The base 50 is connected to the fixed base 4.

Specifically, the fixed base 4 is connected to the handle 1, the electrostatic base 50 is provided with a plurality of third inverted buckles 501. The fixed base 4 is provided with a plurality of third limiting holes 45. The handle 1 is provided with a plurality of first limiting columns 101. The number of the third inverted buckles 501, the third limiting holes 45 and the first limiting columns 101 is same. The third inverted buckles 501 and the first limiting columns 101 can be inserted into the third limiting holes 45.

It can be understood that during the assembly process of the pet comb of the present utility patent, after the third inverted buckle 501 passes out along the third limiting hole 45, the electrostatic base 50 and the fixed base 4 move relatively close to each other, so that the third inverted buckle 501 and the third limiting hole 45 match to each other and realize the fastener fixed structure. Finally, the first limiting column 101 is inserted into the third limiting hole 45 to realize the stable locking connection among the fixed base 4, the handle 1 and the electrostatic base 50.

Referring to FIGS. 1 to 3, in this embodiment, the handle 1 includes a handle top cover 11 and a handle bottom cover 10. The handle top cover 11 is provided with a plurality of second limiting columns 110. The handle bottom cover 10 is provided with a plurality of fourth limiting columns 102. The fourth limiting holes and the second liming columns 110 are matched to each other. The fixed base 4 is provided with a plurality of third limiting columns 46. The handle bottom cover 10 is provided with a plurality of fifth limiting holes 104. The third limiting columns 46 and the fifth limiting holes 104 are matched to each other.

The fixed connection between the handle top cover 11 and the handle bottom cover 10 is realized through the second limiting column 110 and the fourth limiting hole 102. The fixed connection between the handle bottom cover 10 and the fixed base 4 are realized through the third limiting column 46 and the fifth limiting hole 104. Further, two ends of the fixed base 4 and two ends of the handle bottom cover 10 are locked together with screws.

In this embodiment, the handle bottom cover 10 is provided with an installation slot 103. The handle top cover 11 and the handle bottom cover 10 are enclosed to form a second opening (not shown in the figure) on one end of the handle 1. The second opening is connected to the installation slot 103. The installation slot 103 is used for installing a hanging rope 12, and the hanging rope 12 can pass out along the second opening. By the means of setting the hanging rope 12, when the pet comb is not in use, it can be hung in a fixed position so that it is not easily lost. At the same time, the pet comb can be prevented from contacting other surfaces or being accumulated in a humid environment, which helps to keep clean and hygienic and prevent the growth of bacteria for the pet comb.

It can be understood that those skilled in the art can combine various implementation modes of the above embodiments under teaching of the above embodiments to obtain technical solutions of various implementation modes.

The above descriptions are only preferred embodiments of the present utility patent and are not intended to limit the present utility patent. Any modifications, equivalent substitutions, improvements, etc. made within the spirit and principles of the present utility patent shall be included in the protection scope of the present utility patent.

What is claimed is:

1. A pet comb, comprising a handle, a combing component, and an electrostatic component, wherein the combing component comprises a combing base and a combing part; the combing base is connected to the handle, the combing part is arranged on the combing base, the electrostatic component is arranged on one side of the handle, the combing part is configured as an arc-shaped structure, and the arc-shaped structure extends toward the electrostatic component.

2. The pet comb according to claim 1, wherein the pet comb further comprises a fixed base, the fixed base is connected to the handle, and the combing base is connected to the fixed base.

3. The pet comb according to claim 2, wherein both sides of the fixed base are provided with a first opening, the first opening is used for the combing base to pass through, a bottom of the fixed base is provided with a plurality of first limiting holes, a bottom of the combing base is provided with a plurality of first inverted buckles to match with the first limiting holes, a top of the fixed base is provided with a plurality of second limiting holes, a top of the combing base is provided with a plurality of second inverted buckles to match with the second limiting holes.

4. The pet comb according to claim 2, wherein the pet comb further comprises a hair removal device, the hair removal device is movably connected to the fixed base and is covered above the combing part, a toothed hair removal razor is arranged on one side of the hair removal device facing to the combing part, the combing part comprises a toothed hair comb, the hair removal razor and the hair comb are arranged in a staggered manner.

5. The pet comb according to claim 4, wherein the fixed base is provided a column structure, the hair removal device is provided with a snap ring structure, the snap ring structure is provided with an opening, the snap ring structure is sleeved and connected to outer periphery of the column structure through the opening, the hair removal device is capable of rotating with a rotating shaft of the column structure, a reset device is arranged between the hair removal device and the fixed base.

6. The pet comb according to claim 5, wherein both ends of the hair removal device are provided with through holes, both ends of the fixed base are provided with protruding structures, one end of the reset device is sleeved and connected on the protruding structure and is locked and fixed by screws, other end of the reset device is connected into the through hole, the reset device is made of elastic material.

7. The pet comb according to claim 2, wherein the electrostatic component comprises an electrostatic base and an electrostatic cloth, the electrostatic cloth is detachably connected to the electrostatic base, the electrostatic base is connected to the fixed base.

8. The pet comb according to claim 7, wherein the fixed base is connected to the handle, the electrostatic base is provided with a plurality of third inverted buckles, the fixed base is provided with a plurality of third limiting holes, the handle is provided with a plurality of first limiting columns, the third inverted buckles and the first limiting columns are capable of inserting into the third limiting holes.

9. The pet comb according to claim 2, wherein the handle comprises a handle top cover and a handle bottom cover, the handle top cover is provided with a plurality of second limiting columns, the handle bottom cover is provided with a plurality of fourth limiting holes, the fourth limiting holes and the second limiting columns are matched to each other;
the fixed base is provided with a plurality of third limiting columns, the handle bottom cover is provided with a plurality of fifth limiting holes, the third limiting columns and the fifth limiting holes are matched to each other.

10. The pet comb according to claim 9, wherein the handle bottom cover is provided with an installation slot, the handle top cover and the handle bottom cover are enclosed to form a second opening on one end of the handle, the second opening is connected with the installation slot.
